(19) United States
(12) Patent Application Publication
(10) Pub. No.: US 2006/0200552 A1
(43) Pub. Date: Sep. 7, 2006

(54) Method and apparatus for domain-independent system parameter configuration

(76) Inventors: Mandis S. Beigi, Tarrytown, NY (US); Dinesh C. Verma, Mount Kisco, NY (US)

Correspondence Address: MOSER, PATTERSON & SHERIDAN LLP;IBM CORPORATION, 595 SHREWSBURY AVE, SUITE 100, SHREWSBURY, NJ, 07702, US

(21) Appl. No.: 11/073,777

(22) Filed: Mar. 7, 2005

(51) Int. Cl. G06F 15/173

(52) U.S. Cl. 709/224

(57) ABSTRACT

In one embodiment, the present invention is a method and apparatus for dynamic domain-independent system parameter configuration. One embodiment of an inventive method for modifying a current system configuration to achieve a given system objective includes receiving a new system objective. The current system configuration is then modified to achieve the new system objective by applying at least one case history representing past system behavior.

### BACKGROUND

The present invention relates generally to computing systems management, and relates more particularly to the configuration of computing systems parameters to achieve performance objectives.

Policy-based system management provides a means for system administrators, end users and application developers to manage and dynamically change the behavior of computing systems in a simplified and automated environment. This is accomplished in part by allowing system administrators to specify only objectives to be met, as opposed to specifying detailed configuration parameters for each device on the system. These objectives are then translated into the actual configuration parameters that enable the system to achieve the stated objectives.

Translation mechanisms embodying knowledge of the system's inner workings and of techniques for translating specified objectives into configuration parameters are typically domain-specific. As such, adaptation of these translation mechanisms for application in new domains tends to involve a great deal of additional computation, such as the production of analytical system models, the formulation of online control schemes and/or the implementation of neural networks. Moreover, such methods are generally based on a variety of assumptions and simplifications (e.g., artificial workload environments) that affect their practical application to real systems. The adaptation of these domain-specific translation mechanisms is therefore not only tedious and time consuming, but is often speculative at best.

Thus, there is a need in the art for a method and apparatus for domain-independent system parameter configuration.

### SUMMARY OF THE INVENTION

In one embodiment, the present invention is a method and apparatus for domain-independent system parameter configuration. One embodiment of an inventive method for modifying a current system configuration to achieve a given system objective includes receiving a new system objective. The current system configuration is then modified to achieve the new system objective by applying at least one case history representing past system behavior.

### BRIEF DESCRIPTION OF THE DRAWINGS

So that the manner in which the above recited embodiments of the invention are attained and can be understood in detail, a more particular description of the invention, briefly summarized above, may be obtained by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a flow diagram illustrating one embodiment of a method for configuring one or more parameters of a computing system to achieve one or more stated objectives, in accordance with the present invention;

FIG. 2 is a flow diagram illustrating one embodiment of a method for modifying a system configuration based on one or more stored system configurations, according to the present invention; and

FIG. 3 is a high level block diagram of the present method for system parameter configuration that is implemented using a general purpose computing device.

To facilitate understanding, identical reference numerals have been used, where possible, to designate identical elements that are common to the figures.

### DETAILED DESCRIPTION

In one embodiment, the present invention is a method and apparatus for domain-independent system parameter configuration. In one embodiment, the invention is a method for translating system policies or objectives into configuration parameters that achieve the stated objectives. The method exploits knowledge of past system behavior (and associated configuration parameters) in order to dynamically modify system configurations to achieve newly stated objectives, for example by interpolating between previously implemented configuration parameters.

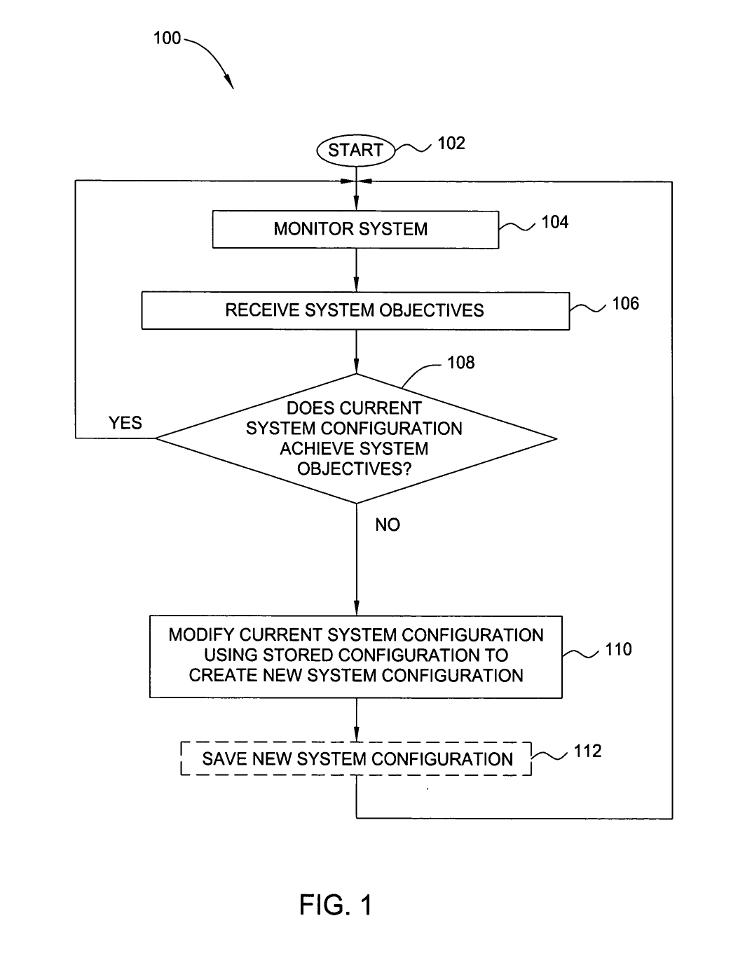

FIG. 1 is a flow diagram illustrating one embodiment of a method 100 for configuring one or more parameters of a computing system to achieve one or more stated objectives, in accordance with the present invention. The method 100 is initialized at step 102 and proceeds to step 104, where the method 100 monitors the computing system. In one embodiment, monitoring of the system in accordance with step 104 involves measuring goal values indicative of the degree to which current system objectives are being met and configuration values indicative of settings of one or more system configuration parameters. In further embodiments, monitoring also involves identifying and/or reporting which, if any, specific current configuration parameters are effective in achieving the system objectives (e.g., by comparing the goal values and the configuration values).

In one embodiment, monitoring of the system further involves capturing data pertaining to the performance (e.g., effectiveness) of current configuration parameters in order to produce a case history. In one embodiment, a case history comprises a mapping between a system configuration's goal values (e.g., as specified by system objectives) and the system configuration's low-level configuration values (e.g., as understandable by the system but not exposed to an administrator through the system objectives). Thus, the case database includes specifications for one or more configuration parameters, the system objectives associated with the configuration parameters, and a degree to which the configuration parameters were successful in achieving the system objectives. In one embodiment, a case history for a single case is generated by averaging the data captured by the method 100 over time (e.g., over two or more measurement intervals).

This case history may be stored, e.g., in a case database, along with other case histories detailing different configuration parameters and system objectives. For example, if a system objective states: “Make sure that during weekdays, the Web server response time is less than two seconds”, the case database may hold a history of all of the different system configurations (e.g., including specified numbers of servers in each tier, or specified numbers of disks per server) and the corresponding server response times achieved by each system configuration.

In step 106, the method 100 receives one or more new system objectives, e.g., from a user. The method 100 then proceeds to step 108 and inquires if the current system configuration is capable of achieving the new system objectives received in step 106. If the method 100 determines that the current system configuration is capable of achieving the newly received system objectives, the method 100 returns to step 104 and continues to monitor the system as described above, e.g., in order to ensure that the system configuration continues to achieve the system objectives received in step 106.

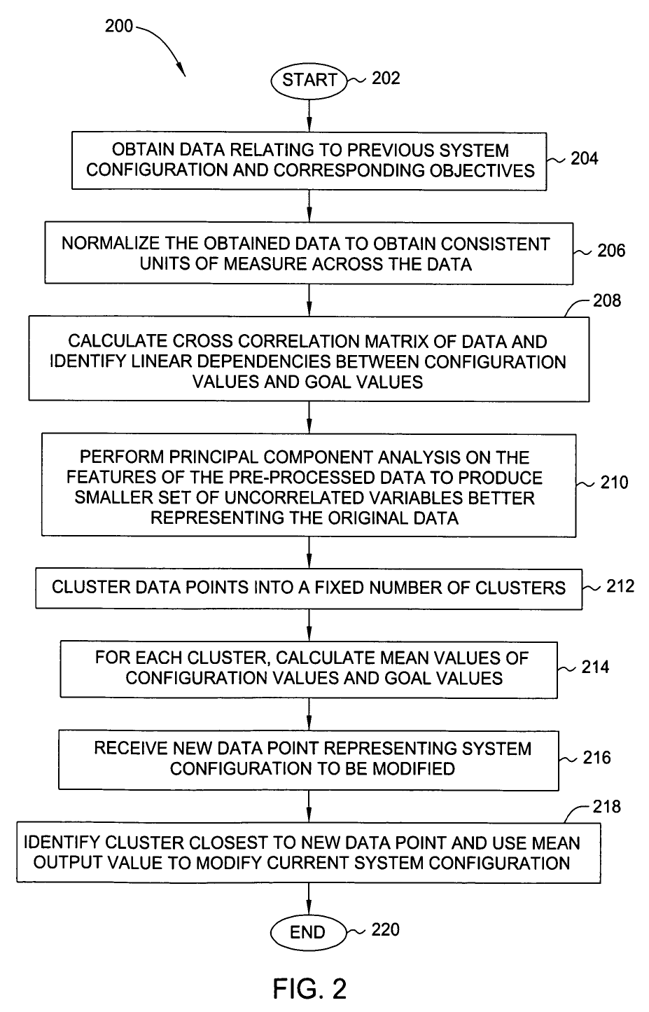

However, if the method 100 concludes in step 108 that the current system configuration is not capable of achieving the newly received system objectives, the method 100 proceeds to step 110 and dynamically modifies the current system configuration to create a new system configuration that is capable of achieving the new system objectives. For example, if the newly received system objective relates to improving the response time of a web server, the method 100 might modify the current system configuration by altering a number of servers on the system, by altering a number of disks in one or more servers, or by altering the processor speed for one or more servers. In one embodiment, the method 100 uses one or more stored system configurations as a guide in the modification process, as described in further detail below in conjunction with FIG. 2. In this embodiment, the method 100 learns more about the system, system objectives and related system configurations every time the method 100 executes and creates new system configurations. Thus, the method 100 performs and tunes with a higher precision for achieving desired system objectives.

In one embodiment, the method 100 proceeds to optional step 112 (illustrated in phantom) and saves the new system configuration parameters and related objectives, e.g., in the case database.

The method 100 thereby offers a means of dynamically modifying system configurations to ensure that changing system objectives are achieved in a substantially consistent manner. Moreover, the dynamic nature of the method 100 (e.g., the method is not trained on static or artificial workloads) enables the method 100 to better respond to actual system workloads, which may change over time. In addition, the method 100 is substantially domain-independent—that is, the method 100 may be implemented for use in substantially any domain with little or no modification.

The method 100 is also particularly well-suited for implementation in disciplines where a mapping from business-level system objectives to system-level configuration parameters is dependent on a current state of the system. For example, configuring parameters such as network bandwidth limitations to achieve system response time objectives would depend at least in part on the system's current workload. While initial configuration tools can only provide estimates of the current system workload, the adaptive nature of the method 100 makes the method 100 much better suited for providing a real-time analysis of the system workload at a given time.

FIG. 2 is a flow diagram illustrating one embodiment of a method 200 for modifying a system configuration based on one or more stored system configurations, according to the present invention. The method 200 is initialized at step 202 and proceeds to step 204, where the method 200 obtains data relating to one or more previous system configurations, the related objectives and the corresponding effectiveness of these system configurations. In one embodiment, the method 200 retrieves the data from one or more databases of case histories. In one embodiment, the method 100 retrieves the data from a group including a limited number of case histories, as opposed to a group including all case histories.

In step 206, the method 200 begins to pre-process the data obtained in step 204 by normalizing the data to obtain consistent units of measure across all of the different measurements. In step 208, the method calculates a cross correlation matrix of the normalized data. In one embodiment, the method 200 calculates the cross correlation matrix in such a way that substantially all configuration values that do not relate to any of the goal values are removed. By removing all goal values that demonstrate little or no dependency on any of the configuration parameters, the dimensionality of the data can be reduced. Thus, by calculating the cross correlation matrix, the method 200 is able to identify linear dependencies between configuration values representing particular configuration parameters and goal values representing a degree to which system objectives were achieved.

In one embodiment, the cross correlation matrix contains the strength and the direction of relationships between all variables in the normalized data (e.g., relating to configuration parameters and their performance or effectiveness). From this information, one can estimate the effects of modifying various configuration parameters. For example, the direction of a relationship indicates whether increasing a particular configuration parameter (e.g., increasing a number of disks in a server) will increase, decrease, or have no substantial effect on a particular goal value (e.g., decrease server response time). The strength of a relationship indicates how much the tuning or modifying the particular configuration parameter will increase or decrease the particular goal value. Thus, steps 206 and 208 serve to preprocess the data from the case histories for use in the system configuration modification process.

In step 210, the method 200 performs a principal component analysis on features of the pre-processed data in order to produce a smaller set of uncorrelated variables that better represent the original data (e.g., the data as originally obtained in step 204). This substantially reduces the complexity of the data, which may comprise a large number (e.g., thousands) of interrelated variables.

In step 212, the method 200 clusters the remaining data in order to produce a fixed number, k, of clusters of data. In one embodiment, the fixed number of clusters, k, is predefined by a user. In one embodiment, the number of clusters, k, is directly proportional to a number of collected data points. For example, in one embodiment, a rule of thumb dictates that a minimum of ten data points per dimension should be clustered together. In one embodiment, data is clustered in accordance with step 210 using a known clustering technique, such as the k-nearest neighbor clustering technique. In this embodiment, k data points are randomly selected from the available data and assigned to separate clusters. The remaining data points are then assigned to one of the k clusters to create k initial clusters.

In a first embodiment, a data point is assigned to the closest cluster, e.g., the cluster for which the distance between the data point and the mean of the cluster is smallest. In a second embodiment, each cluster is assumed to have a Gaussian distribution, and the most appropriate cluster for a given data point is selected using a Gaussian density function. That is, every time a data point is assigned to a cluster, the cluster's mean is re-calculated or updated. Data points may then be reassigned from an initial cluster to a closer cluster, and reassignment continues until the means of all of the clusters stabilize (e.g., remain the same or vary by a very small threshold amount). While the assignment technique of the first embodiment is easier than the second (and thus may be less time consuming), the assignment technique of the second embodiment is generally more accurate, particularly where there are many large overlaps in the data (e.g., variances are large). Clustering the data in according with step 212 makes the method 200 more robust to noise in the data, as well as limits the search space to distinctly different cases (e.g., eliminates redundancies in the data, which improves performance).

In step 214, the method 200 calculates, for each cluster, a mean value of all of the configuration values of the data points within that cluster. In addition, the method 200 also calculates a mean value of all of the corresponding goal values of all of the data points.

In step 216, the method 200 receives a new data point representing a current system configuration to be modified (e.g., in accordance with step 110 of FIG. 1). The method 200 then proceeds to step 218 and identifies the cluster closest to this new data point, e.g., using a known distance metric such as Euclidean distance, weighted Euclidean distance or Mahalanobis distance. The method 200 then uses the mean output value of the closest cluster to modify the current system configuration represented by the new data point. In one embodiment, the mean output value of a cluster represents either the cluster's mean goal value or the cluster's mean configuration value, depending on the direction of the transformation to be made. For example, in order to infer a set of goal values from a given set of configuration values, input values would represent configuration values, and the mean output value would represent a corresponding goal value (and the converse is true for inferring a set of configuration values from a given set of goal values). Once the closest cluster is identified for at least one given goal value, the corresponding values for the configuration parameters are applied to the current system configuration (e.g., after appropriate modification or tuning). In step 220, the method 200 terminates.

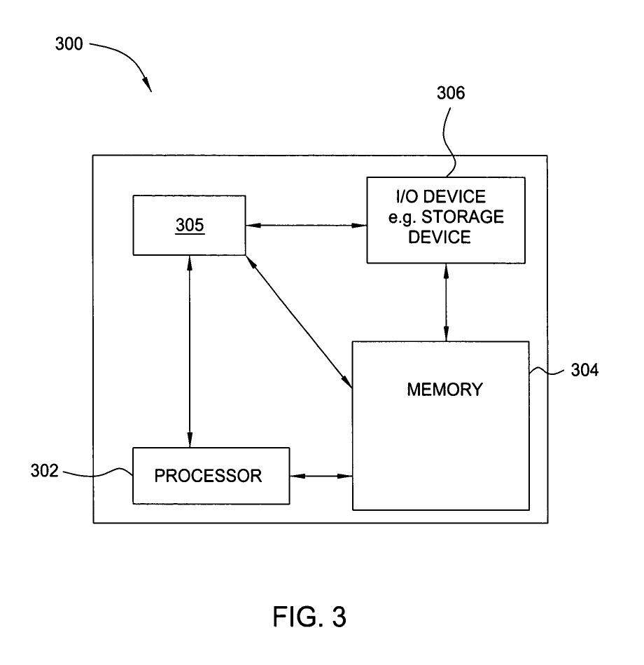

FIG. 3 is a high level block diagram of the present method for system parameter configuration that is implemented using a general purpose computing device 300. In one embodiment, a general purpose computing device 300 comprises a processor 302, a memory 304, a configuration transformation module 305 and various input/output (I/O) devices 306 such as a display, a keyboard, a mouse, a modem, and the like. In one embodiment, at least one I/O device is a storage device (e.g., a disk drive, an optical disk drive, a floppy disk drive). It should be understood that the configuration transformation module 305 can be implemented as a physical device or subsystem that is coupled to a processor through a communication channel.

Alternatively, the configuration transformation module 305 can be represented by one or more software applications (or even a combination of software and hardware, e.g., using Application Specific Integrated Circuits (ASIC)), where the software is loaded from a storage medium (e.g., I/O devices 306) and operated by the processor 302 in the memory 304 of the general purpose computing device 300. Thus, in one embodiment, the configuration transformation module 305 for dynamically modifying system configuration parameters described herein with reference to the preceding Figures can be stored on a computer readable medium or carrier (e.g., RAM, magnetic or optical drive or diskette, and the like).

Thus, the present invention represents a significant advancement in the field of systems management. The system and methods of the present invention allow system configuration parameters to be dynamically modified by evaluating real workloads and real configuration case histories, ensuring that changing system objectives are achieved in a substantially consistent manner. In addition, the method is substantially domain-independent and may be implemented for use in substantially any domain with little or no modification.

While foregoing is directed to the preferred embodiment of the present invention, other and further embodiments of the invention may be devised without departing from the basic scope thereof, and the scope thereof is determined by the claims that follow.

1. A method for modifying a current system configuration of a system, said method comprising:
receiving at least one system objective; and
applying at least one case history representing past behavior of said system in order to modify one or more parameters of said current system configuration for achieving said at least one system objective.

2. The method of claim 1, where said at least one case history is stored in a database of case histories.

3. The method of claim 1, wherein said at least one case history comprises at least one configuration value representing one or more parameters of a previous system configuration, at least one previous objective associated with said previous system configuration, and at least one goal value representing a degree to which one or more parameters of said previous system configuration are successful in achieving said at least one previous objective.

4. The method of claim 3, wherein said applying step comprises:
receiving a data point representing said current system configuration;
identifying, from among two or more clusters of data points representing previous system configurations, a cluster for which a mean configuration value is closest to a configuration value of said received data point; and
applying a mean output value of said identified cluster to said received data point to produce a modified system configuration.

5. The method of claim 4, wherein said identifying step comprises applying at least one of a Euclidean distance, a weighted Euclidean distance, or a Mahalanobis distance in order to select said identified cluster.

6. The method of claim 4, wherein said previous system configurations are grouped into said two or more clusters by:
obtaining two or more data points corresponding, respectively, to two or more previous system configurations, each of said two or more previous system configurations having at least one configuration value and at least one goal value;
normalizing said two or more data points to obtain common units of measure across said two or more data points; and
grouping said normalized two or more data points into two or more clusters having mean configuration values.

7. The method of claim 6, wherein said normalizing step further comprises:
identifying, within said normalized two or more data points, linear dependencies between configuration values and goal values.

8. The method of claim 7, wherein said identifying step comprises:
calculating a cross correlation matrix of said normalized two or more data points.

9. The method of claim 6, wherein said grouping step comprises:
selecting a predefined number of data points from among said two or more data points to represent said two or more clusters; and
assigning each unselected data point to one of said two or more clusters.

10. The method of claim 9, wherein said assigning step comprises:
allocating an unselected data point to a closest cluster, said closest cluster being a cluster for which a distance between said closest cluster's mean configuration value and said unselected data point's configuration value is smallest.

11. The method of claim 9, wherein said assigning step comprises:
allocating an unselected data point to a first cluster;
calculating a new mean configuration value for said first cluster based on the addition of said unselected data point to said first cluster; and
reassigning said unselected data point to at least a second cluster from said two or more clusters, where said reassignment results in a stabilization of all mean configuration values of all of said two or more clusters.

12. The method of claim 1, further comprising the step of:
storing said modified system configuration as a new case history.

13. The method of claim 1, wherein said at least one case history is generated by averaging, over a given period of time, one or more metrics associated with a related previous system configuration.

14. The method of claim 13, wherein said one or more metrics include at least one configuration value representing one or more parameters of said previous system configuration, at least one previous objective associated with said previous system configuration, and at least one goal value representing a degree to which said one or more parameters of said at previous system configuration are successful in achieving said at least one previous objective.

15. A computer readable medium containing an executable program for modifying a current system configuration of a system, where the program performs the steps of:
receiving at least one system objective; and
applying at least one case history representing past behavior of said system in order to modify one or more parameters of said current system configuration for achieving said at least one system objective.

16. The computer readable medium of claim 15, wherein said at least one case history comprises at least one configuration value representing one or more parameters of a previous system configuration, at least one previous objective associated with said previous system configuration, and at least one goal value representing a degree to which one or more parameters of said previous system configuration are successful in achieving said at least one previous objective.

17. The computer readable medium of claim 16, wherein said applying step comprises:
receiving a data point representing said current system configuration;
identifying, from among two or more clusters of data points representing previous system configurations, a cluster for which a mean configuration value is closest to a configuration value of said received data point; and
applying a mean output value of said identified cluster to said received data point to produce a modified system configuration.

18. The computer readable medium of claim 17, wherein said previous system configurations are grouped into said two or more clusters by:
obtaining two or more data points corresponding, respectively, to two or more previous system configurations, each of said two or more previous system configurations having at least one configuration value and at least one goal value;
normalizing said two or more data points to obtain common units of measure across said two or more data points; and
grouping said normalized two or more data points into two or more clusters having mean configuration values.

19. The computer readable medium of claim 15, further comprising the step of:
storing said modified system configuration as a new case history.

20. Apparatus for modifying a current system configuration of a system comprising:
means for receiving at least one system objective; and
means for applying at least one case history representing past behavior of said system in order to modify one or more parameters of said current system configuration for achieving said at least one system objective.
